(19) United States
(12) Patent Application Publication
(10) Pub. No.: US 2009/0249799 A1
(43) Pub. Date: Oct. 8, 2009

(54) APPARATUS AND METHOD FOR INCREASING EFFICIENCY OF A GAS TURBINE AND A MARINE STRUCTURE HAVING THE SAME

(75) Inventors: Jung Han Lee, Geoje-si (KR); Dong Kyu Choi, Geoje-si (KR); Young Soo Kim, Geoje-si (KR)

Correspondence Address: SEED INTELLECTUAL PROPERTY LAW GROUP PLLC, 701 FIFTH AVE, SUITE 5400, SEATTLE, WA, 98104, US

(73) Assignee: DAEWOO SHIPBUILDING & MARINE ENGINEERING CO., LTD., Seoul (KR)

(21) Appl. No.: 12/175,231

(22) Filed: Jul. 17, 2008

(30) Foreign Application Priority Data
Apr. 7, 2008 (KR) 10-2008-0031955

(51) Int. Cl. F17C 9/04; F17C 13/08; F25B 39/02; F17C 9/00; F02C 6/18

(52) U.S. Cl. 62/50.3; 62/53.2; 62/515; 62/50.4; 60/780

(57) ABSTRACT

An apparatus and method for increasing efficiency of a gas turbine and a marine structure having the gas turbine are disclosed. The marine structure has a cargo tank for storing cryogenic liquefied natural gas (LNG) and a gas turbine for generating electric power. The marine structure further includes a heat exchanger to cool air for combustion supplied to the gas turbine using a cold source or cold heat of the LNG stored in the cargo tank, a heat transfer medium circuit to indirectly transfer the cold source of the LNG stored in the cargo tank to the heat exchanger, and a heater to heat a heat transfer medium having undergone heat exchange with the air for combustion while passing through the heat exchanger. The temperature of air supplied to the gas turbine is lowered using the cold source generated upon regasification of LNG in the marine structure, thereby increasing the efficiency of the gas turbine.

### BACKGROUND

1. Technical Field

The present invention generally relates to systems with gas turbines, and more particularly, to an apparatus and method for increasing efficiency of a gas turbine. The present invention also relates to a marine structure having the gas turbine.

2. Description of the Related Art

In recent years, the use of natural gas has rapidly expanded throughout the world. Natural gas is transported long distances in a gaseous state through a gas pipe line over land or sea, or is transported in a liquid state to consumers by liquefied natural gas (LNG) carriers. LNG is obtained by cooling natural gas into a cryogenic state (about −63° C.) where the volume of the natural gas is reduced to about 1/600 that at standard temperature and pressure, which makes it eminently suitable for long distance marine transportation.

The LNG carrier is provided for shipping and discharging the LNG when carrying it to a land destination by sea. For this purpose, the LNG carrier includes an LNG storage tank (e.g., a cargo tank) capable of withstanding the cryogenic state of the LNG. Typically, the LNG carrier discharges the LNG from the LNG storage tank at a destination in the liquefied state, and the discharged LNG is regasified by LNG regasification equipment installed at the destination and is then supplied to natural gas consumers through the gas pipe line.

The land-based LNG regasification equipment is economically advantageous in the case where the equipment is installed in such a place where natural gas markets are actively and stably established to satisfy demand for natural gas. However, the land-based LNG regasification equipment is economically disadvantageous in the case where the equipment is installed in such a place where a market for natural gas is seasonal, short-term or periodic, since installation and maintenance of the LNG regasification equipment is relatively expensive.

In particular, if the LNG regasification equipment is destroyed by natural disasters or the like, even though the LNG carrier arrives at the destination to discharge the LNG, it is impossible to regasify the LNG. Therefore, there is a limit in transportation of the natural gas through the conventional LNG carrier.

Accordingly, there has been developed a marine LNG regasification system wherein LNG regasification equipment is installed in the LNG carrier or a marine structure to regasify the LNG at sea and supply natural gas obtained by the regasification to the land.

Examples of the marine structure with the LNG regasification equipment include an LNG RV (regasification vessel), an LNG FSRU (floating storage and regasification unit), etc. Additionally, an LNG FPSO (floating, production, storage and off-loading) or a similar marine structure may have the LNG regasification equipment.

The LNG RV is a floating LNG carrier that has LNG regasification equipment and is seafaring. The LNG FSRU is a floating marine structure that can store LNG, unloaded from an LNG carrier, in a cargo tank at sea a long distance from the land to gasify the LNG as needed, thereby supplying the regasified LNG to consumers on the land. The LNG FPSO is a floating marine structure that directly liquefies natural gas into LNG at sea and stores the LNG in an LNG cargo tank thereof to deliver the LNG stored in the LNG cargo tank to another LNG carrier as needed.

In such marine structures, a gas turbine is used for generating electric power. The lower the temperature of combustion air supplied to the gas turbine, the higher the efficiency of the gas turbine.

An evaporative cooling method has been proposed to lower the temperature of the combustion air to increase the efficiency of the gas turbine. In this method, water is forced to flow together with air into or is sprayed into the gas turbine, so that air can be cooled during evaporation of water. Such evaporative cooling methods are disclosed in U.S. Pat. No. 5,390,505, Japanese Patent Laid-open Publication No. H08-151933, etc.

However, since the conventional method employs only latent heat resulting from evaporation of water to cool air for improving the efficiency of the gas turbine, there is a limit to lower the temperature of air below a condensation point of moist air. Particularly, under the condition that the atmospheric temperature is low (e.g., in winter or at high latitudes), such a conventional method has problems in that efficiency of the gas turbine can be decreased and output thereof can become unstable depending on the atmospheric temperature.

### BRIEF SUMMARY

According to one embodiment, an apparatus and a method for increasing efficiency of a gas turbine are provided. The apparatus is configured to lower a temperature of air supplied to the gas turbine using a cold source or cold heat generated upon regasification of LNG in a marine structure having LNG regasification equipment. According to another embodiment, a marine structure having the gas turbine is provided. The cold source is also referred to as cold heat in at least some applications in the field, and can include absorbing energy and producing a cooling effect, for example generated from regasification of the LNG.

In accordance with an embodiment, the marine structure includes a cargo tank to store cryogenic liquefied natural gas (LNG) and a gas turbine for generating electric power, including: a heat exchanger to cool air for combustion supplied to the gas turbine using a cold source of the LNG stored in the cargo tank; a heat transfer medium circuit to indirectly transfer the cold source of the LNG stored in the cargo tank to the heat exchanger; and a heater to heat a heat transfer medium having been subjected to heat exchange with the air for combustion while passing through the heat exchanger. The cold source is also referred to as cold heat in at least some applications in the field, and can include absorbing energy and producing a cooling effect, for example generated from regasification of the LNG.

In accordance with another embodiment, the marine structure includes a cargo tank to store cryogenic LNG and a gas turbine for generating electric power, the marine structure including: a heat exchanger to cool air for combustion supplied to the gas turbine using a cold source of the LNG stored in the cargo tank.

In one aspect, the marine structure may further include a heat transfer medium circuit to indirectly transfer the cold source of the LNG stored in the cargo tank to the heat exchanger.

In one aspect, the marine structure may further include an LNG vaporizer to regasify the LNG stored in the LNG cargo tank, wherein the air for combustion supplied to the gas turbine is cooled by the cold source generated upon regasification of the LNG in the LNG vaporizer.

In one aspect, the heat transfer medium circuit may include a heater to heat a heat transfer medium having been subjected to heat exchange with the air for combustion while passing through the heat exchanger.

In one aspect, the heat transfer medium circuit may include an LNG vaporizer to regasify the LNG via heat exchange with the heat transfer medium, the heat exchanger to cool the air for combustion supplied to the gas turbine via heat exchange with the heat transfer medium, and a heat transfer medium transfer pump to transfer the heat transfer medium.

In one aspect, the heat transfer medium circuit may further include a heat transfer medium adjusting valve to adjust an amount of heat transfer medium transferred by the heat transfer medium transfer pump.

In one aspect, the heat transfer medium may be one selected from thermal oil, glycol water and an evaporative refrigerant, which have low freezing points to prevent the heat transfer medium from being frozen due to the heat exchange with the cryogenic LNG.

In one aspect, the LNG regasified by the LNG vaporizer may be used as fuel for the gas turbine.

In one aspect, the heat transfer medium circuit may be a closed circuit.

In one aspect, the marine structure may be a marine floating structure having LNG regasification equipment and selected from an LNG RV (regasification vessel), an LNG FSRU (floating storage and regasification unit), and an LNG FPSO (floating, production, storage and off-loading).

In accordance with a further embodiment, a method for increasing efficiency of a gas turbine in a marine structure is provided. Here, the marine structure has a cargo tank for storing cryogenic LNG and a gas turbine for generating electric power. The method includes cooling air for combustion supplied to the gas turbine using a cold source of the LNG stored in the cargo tank.

In one aspect, the method may include: regasifying the LNG via heat exchange with a heat transfer medium; cooling the air for combustion via heat exchange with the heat transfer medium receiving a cold source generated during regasification of the LNG; and supplying the cooled air for combustion to the gas turbine.

In one aspect, the method may further include additionally heating the heat transfer medium, having been heated via the heat exchange with the air for combustion, by thermal energy from an exterior.

In one aspect, the method may further include adjusting a cooling temperature of the air for combustion by adjusting an amount of heat transfer medium undergoing the heat exchange with the air for combustion.

In accordance with yet another embodiment, a method for increasing efficiency of a gas turbine in a marine structure is provided. The marine structure has a cargo tank for storing cryogenic LNG and a gas turbine for generating electric power. The method includes: cooling air for combustion supplied to the gas turbine by indirectly receiving a cold source of the LNG stored in the cargo tank via a heat transfer medium; and additionally heating the heat transfer medium, having been heated via heat exchange with the air for combustion, by thermal energy from an exterior.

As described above, embodiments of the present invention provide a method for increasing efficiency of the gas turbine by lowering the temperature of air supplied to the gas turbine using a cold source generated upon regasification of LNG in a marine structure with LNG regasification equipment.

Further, embodiments of the present invention provide a marine structure that has a gas turbine and can lower the temperature of air supplied to the gas turbine using a cold source generated upon regasification of LNG, thereby improving efficiency of the gas turbine.

Therefore, the temperature of air supplied to the gas turbine can be stably and constantly maintained regardless of the external atmospheric temperature to thereby maintain the output of the gas turbine. Further, since a gas turbine according to an embodiment of the present invention provides a higher output than the conventional gas turbine with similar consumption requirements, it is possible to reduce fuel consumption of the gas turbine while supplying sufficient power to the marine structure.

### BRIEF DESCRIPTION OF THE SEVERAL VIEWS OF THE DRAWINGS

The above and other objects, features and advantages will become apparent from the following description of the disclosed embodiments given in conjunction with the accompanying drawings, in which:

FIG. 1A is a schematic view illustrating a marine structure according to one embodiment.

FIG. 1B is a schematic view illustrating an apparatus and a method for increasing efficiency of a gas turbine according to one embodiment; and

FIG. 1C is a schematic view illustrating an apparatus and a method for increasing efficiency of a gas turbine according to another embodiment.

### DETAILED DESCRIPTION

Some embodiments will be described in detail with reference to the accompanying drawings hereinafter.

Herein, the term “marine structure” refers to any structure or vessel including a cargo tank to store liquid goods such as liquefied natural gas (LNG) in a cryogenic state and is used while floating at sea. Examples of the marine structure include, but are not limited to, an LNG FPSO (floating, production, storage and off-loading), an LNG FSRU (floating storage and regasification unit), an LNG RV (regasification vessel), and the like.

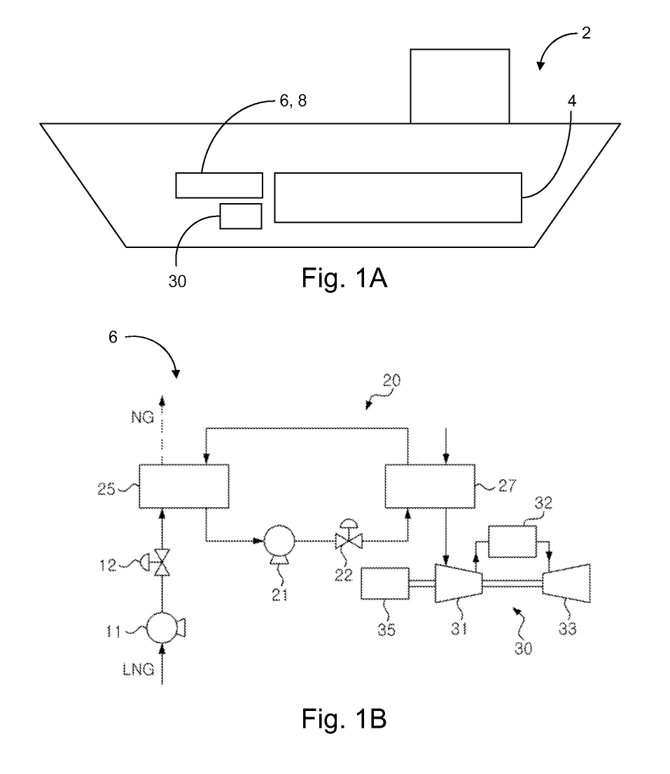

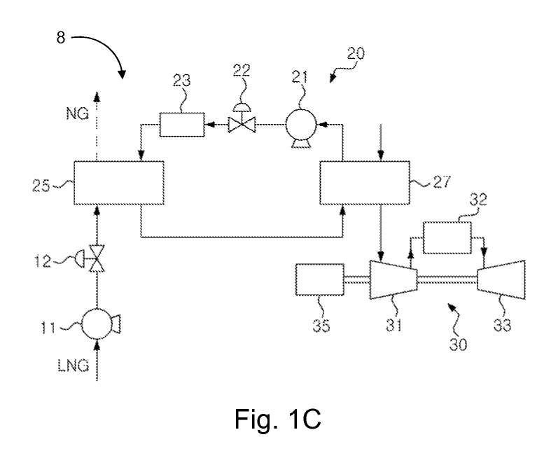

FIG. 1A illustrates a marine structure 2 including a gas turbine 30, an LNG cargo tank 4 that stores LNG in a cryogenic state, and an apparatus 6, 8 (see FIGS. 1B and 1C) for increasing efficiency of a gas turbine, according to one embodiment. FIG. 1B is a schematic view illustrating the apparatus and method 6 for increasing efficiency of a gas turbine, according to one embodiment. As shown in FIG. 1B, the LNG is regasified by an LNG vaporizer 25 as needed, and is then supplied to a place of demand or is supplied for use as a fuel for various devices mounted on the marine structure, or for any other suitable purpose.

In the LNG vaporizer 25, heat exchange between the LNG and a heat transfer medium occurs to cause the LNG to be regasified by heat from the heat transfer medium while causing the heat transfer medium to be cooled and condensed by a cold source or cold heat from the LNG upon regasification of the LNG. The amount of LNG supplied from the LNG cargo tank to the LNG vaporizer 25 by an LNG transfer pump 11 can be adjusted by an LNG adjusting valve 12.

According to one embodiment, a heat transfer medium circuit 20 includes the LNG vaporizer 25, a heat transfer medium transfer pump 21, a heat transfer medium adjusting valve 22, and a heat exchanger 27. The heat transfer medium circuit 20 is a closed circuit, so that the heat transfer medium sequentially circulates through the LNG vaporizer 25, the heat transfer medium transfer pump 21, the heat transfer medium adjusting valve 22, and the heat exchanger 27.

After being cooled while passing through the LNG vaporizer 25, the heat transfer medium enters the heat exchanger 27 and cools air supplied toward an inlet of the gas turbine 30. In the heat transfer medium circuit 20, circulation of the heat transfer medium is carried out by the heat transfer medium transfer pump 21 and the amount of heat transfer medium supplied to the heat exchanger 27 can be adjusted by the heat transfer medium adjusting valve 22. The heat transfer medium condensed by a cold source from the LNG in the LNG vaporizer 25 can be deprived of the cold source and vaporized while cooling air in the heat exchanger 27.

The temperature of air supplied to the gas turbine 30 through the heat exchanger 27 can be adjusted by adjusting the amount of heat transfer medium supplied to the heat exchanger 27 via the heat transfer medium adjusting valve 22. Further, even in a case where the temperature of air is varied according to surrounding temperatures, the temperature of air supplied to the gas turbine 30 can be stably maintained by adjusting the amount of heat transfer medium as mentioned above.

Before passing through the heat exchanger 27, the temperature of air is generally about 0˜45° C. depending on the circumstances such as seasons and latitudes. However, the temperature of air can be lowered by about 5˜30° C. via heat exchange in the heat exchanger 27. For reference, when the temperature of air supplied to the gas turbine 30 is lowered by about 27° C., the efficiency of the gas turbine 30 can be improved by about 10%.

After being cooled by the cold source from the heat exchanger medium in the heat exchanger 27, air is supplied to the gas turbine 30. More specifically, the cooled air is supplied toward an inlet of an air compressor 31 included in the gas turbine 30 to compress air before combustion. Then, air compressed by the compressor 31 is supplied into a combustor 32 where the compressed air is mixed with fuel and combusted therewith, in some embodiments, driving a turbine 33 and a generator 35.

The turbine 33, the air compressor 31 and the generator 35 may all be connected to a single shaft, and electric power generated by the generator 35 may be used to drive various devices provided in the marine structure or used as a power source, or any other suitable purpose. That is, the gas turbine 30 is disposed to generate electric power or to generate motive power. Natural gas regasified in the ambient LNG vaporizer 25 may be used as fuel for the gas turbine 30.

FIG. 1C is a schematic view illustrating the apparatus and method 8 for increasing efficiency of a gas turbine according to another embodiment. For convenience, like numerals denote like elements to those of the first embodiment.

As shown in FIG. 1C, the LNG is regasified by an LNG vaporizer 25 as needed, and is then supplied to a place of demand or is supplied for use as a fuel for various devices mounted on the marine structure, or for any other suitable purpose.

In the LNG vaporizer 25, heat exchange between the LNG and a heat transfer medium occurs to cause the LNG to be regasified by heat from the heat transfer medium while causing the heat transfer medium to be cooled and condensed by a cold source or cold heat from the LNG upon regasification of the LNG. The amount of LNG supplied from the LNG cargo tank to the LNG vaporizer 25 by an LNG transfer pump 11 can be adjusted by an LNG adjusting valve 12.

In one aspect, the heat transfer medium may be one of thermal oil, glycol water and an evaporative refrigerant, which have low freezing points to prevent the heat transfer medium from being frozen due to the heat exchange with the cryogenic LNG.

Examples of conventional techniques using the heat transfer medium are disclosed in U.S. Pat. No. 2,975,607, No. 3,986,340, No. 6,367,258, No. 6,688,114, and No. 6,945,049. However, these conventional techniques do not employ a cold source from the LNG upon regasification of the LNG.

The thermal oil is a kind of mineral oil and can be used at a very wide range of temperatures (˜10˜320° C.). The glycol water is a mixture of water and glycol where water comprises 30˜50% and water comprises 70˜50%, and can also be uses at a very wide range of temperatures (−30˜100° C.).

According to one embodiment, a heat transfer medium circuit 20 includes the LNG vaporizer 25, a heat exchanger 27, a heat transfer medium transfer pump 21, a heat transfer medium adjusting valve 22, and a heater 23. The heat transfer medium circuit 20 is a closed circuit, so that the heat transfer medium sequentially circulates through the LNG vaporizer 25, the heat exchanger 27, the heat transfer medium transfer pump 21, the heat transfer medium adjusting valve 22, and the heater 23.

After being cooled while passing through the LNG vaporizer 25, the heat transfer medium enters the heat exchanger 27 and cools air supplied toward an inlet of the gas turbine. In the heat transfer medium circuit 20, circulation of the heat transfer medium is carried out by the heat transfer medium transfer pump 21 and the amount of heat transfer medium supplied to the heater 23, that is, the amount of circulating heat transfer medium, can be adjusted by the heat transfer medium adjusting valve 22. The heat transfer medium cooled by the cold source from the LNG in the LNG vaporizer 25 is deprived of a cold source or cold heat by cooling air in the heat exchanger 27. In other words, the heat transfer medium is heated by the air in the heat exchanger 27. Then, the heat transfer medium heated by the air may be further heated to a high temperature by the heater 23.

If the heat transfer medium is the thermal oil or the glycol water, the heat transfer medium is cooled to about −10˜0° C. while passing through the LNG vaporizer 25. If the heat transfer medium is the evaporative refrigerant, the heat transfer medium is cooled and condensed to about ˜50˜0° C. while passing through the LNG vaporizer 25. Then, the heat transfer medium cooled to a low temperature cools room temperature air into low temperature air while passing through the heat exchanger 27. Here, since the heat transfer medium heated through the heat exchanger 27 still has a lower temperature than atmospheric temperature, the heat transfer medium is further heated for regasification of the LNG. The heater 23 serves to supply an additional heat source to the heat transfer medium. After passing through the heater 23, the heat transfer medium has a temperature of about 0˜90° C. according to the kind of heat transfer medium and is supplied to the LNG vaporizer 25.

To increase the temperature of the heat transfer medium, the heater is configured to employ a thermal oil system, a glycol water system or an evaporative refrigeration system.

The temperature of air supplied to the gas turbine 30 through the heat exchanger 27 can be adjusted by adjusting the amount of heat transfer medium supplied to the heat exchanger 27 via the heat transfer medium adjusting valve 22. Further, even in the case where the temperature of air is varied according to surrounding temperatures, the temperature of air supplied to the gas turbine 30 can be stably maintained by adjusting the amount of heat transfer medium as mentioned above.

After being cooled by the cold source from the heat exchanger medium in the heat exchanger 27, air is supplied to the gas turbine 30. More specifically, the cooled air is supplied toward an inlet of an air compressor 31 included in the gas turbine 30 to compress air before combustion. Air compressed by the compressor 31 is supplied into a combustor 32 where the compressed air is mixed with fuel and combusted therewith, in one embodiment, driving a turbine 33 and a generator 35.

The turbine 33, the air compressor 31 and the generator 35 may all be connected to a single shaft, and electric power generated by the generator 35 may be used to drive various devices provided in the marine structure or used as a power source. In other words, the gas turbine 30 is disposed to generate electric power or to generate motive power. In some embodiments, natural gas regasified in the ambient LNG vaporizer 25 may be used as fuel for the gas turbine 30.

As apparent from the above description, according to embodiments of the present invention, the temperature of air supplied to a gas turbine can be lowered by vaporization heat of LNG, thereby noticeably enhancing efficiency of the gas turbine. Further, the temperature of air supplied to the gas turbine can be stably and constantly maintained regardless of the external atmospheric temperature to thereby maintain a constant gas turbine output.

According to embodiments of the present invention, a heat transfer medium can be supplied into an LNG vaporizer after being heated by a heater, thereby eliminating additional supply of thermal energy for regasification of the LNG.

Further, according to embodiments of the present invention, a cold source of the LNG is transferred to air through the heat transfer medium which prevents direct heat exchange between the LNG and air, so that the likelihood of mixture between air supplied to the gas turbine and a methane component of the LNG can be fundamentally removed, thereby improving stability of operation.

As such, according to embodiments of the present invention, gas turbine having similar fuel consumption requirements as a conventional gas turbine, can have an output higher than the conventional gas turbine, thereby reducing fuel consumption and supplying requisite power to the marine structure.

Although some embodiments of an apparatus and method for increasing efficiency of the gas turbine with a cold source from LNG and the marine structure having the gas turbine have been described with reference to the embodiments and the accompanying drawings, the present invention is not limited to the embodiments and the drawings. It should be understood that various modifications and changes can be made by those skilled in the art without departing from the spirit and scope of the present invention as defined by the accompanying claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A marine structure comprising:
a cargo tank configured to store cryogenic liquefied natural gas (LNG);
a gas turbine configured to generate electric power or driving power;
a heat exchanger to cool air for combustion supplied to the gas turbine using a cold source of the LNG stored in the cargo tank;
a heat transfer medium circuit to indirectly transfer the cold source of the LNG stored in the cargo tank to the heat exchanger; and
a heater to heat a heat transfer medium having been subjected to heat exchange with the air for combustion while passing through the heat exchanger.

2. A marine structure comprising:
a cargo tank configured to store cryogenic LNG;
a gas turbine configured to generate electric power or driving power; and
a heat exchanger to cool air for combustion supplied to the gas turbine using a cold source of the LNG stored in the cargo tank.

3. The marine structure according to claim 2, further comprising:
a heat transfer medium circuit to indirectly transfer the cold source of the LNG stored in the cargo tank to the heat exchanger.

4. The marine structure according to claim 2, further comprising:
an LNG vaporizer to regasify the LNG stored in the LNG cargo tank,
wherein the air for combustion supplied to the gas turbine is cooled by the cold source generated upon regasification of the LNG in the LNG vaporizer.

5. The marine structure according to claim 3, wherein the heat transfer medium circuit includes a heater to heat a heat transfer medium having been subjected to heat exchange with the air for combustion while passing through the heat exchanger.

6. The marine structure according to claim 3, wherein the heat transfer medium circuit comprises an LNG vaporizer to regasify the LNG via heat exchange with the heat transfer medium, the heat exchanger to cool the air for combustion supplied to the gas turbine via heat exchange with the heat transfer medium, and a heat transfer medium transfer pump to transfer the heat transfer medium.

7. The marine structure according to claim 6, wherein the heat transfer medium circuit further comprises a heat transfer medium adjusting valve to adjust an amount of heat transfer medium transferred by the heat transfer medium transfer pump.

8. The marine structure according to claim 3, wherein the heat transfer medium is one selected from at least one of thermal oil, glycol water and an evaporative refrigerant, to prevent the heat transfer medium from being frozen due to the heat exchange with the cryogenic LNG.

9. The marine structure according to claim 4, wherein the LNG regasified by the LNG vaporizer is supplied as fuel to the gas turbine.

10. The marine structure according to claim 3, wherein the heat transfer medium circuit is a closed circuit.

11. The marine structure according to claim 2, wherein the marine structure is at least one of a marine floating structure having LNG regasification equipment and selected from an LNG RV (regasification vessel), an LNG FSRU (floating storage and regasification unit) and an LNG FPSO (floating, production, storage and off-loading).

12. A method for increasing efficiency of a gas turbine in a marine structure, the marine structure having a cargo tank for storing cryogenic LNG and a gas turbine for generating electric power or driving power, the method comprising:
cooling air for combustion supplied to the gas turbine using a cold source of the LNG stored in the cargo tank.

13. The method according to claim 12, comprising:
regasifying the LNG via heat exchange with a heat transfer medium;
cooling the air for combustion via heat exchange with the heat transfer medium receiving the cold source generated upon regasification of the LNG; and
supplying the cooled air for combustion to the gas turbine.

14. The method according to claim 13, further comprising:
additionally heating the heat transfer medium, having been heated via the heat exchange with the air for combustion, by thermal energy from an exterior.

15. The method according to claim 13, further comprising:
adjusting a cooling temperature of the air for combustion by adjusting an amount of heat transfer medium undergoing the heat exchange with the air for combustion.

16. A method for increasing efficiency of a gas turbine in a marine structure, the marine structure having a cargo tank for storing cryogenic LNG and a gas turbine for generating electric power, the method comprising:
cooling air for combustion supplied to the gas turbine by indirectly receiving a cold source of the LNG stored in the cargo tank via a heat transfer medium; and
additionally heating the heat transfer medium, having been heated via heat exchange with the air for combustion, by thermal energy from an exterior.

17. An apparatus to increase efficiency of a gas turbine, the apparatus comprising:
a heat exchanger to cool air for combustion supplied to the gas turbine using a cold source of LNG; and
a heat transfer medium circuit to indirectly transfer the cold source of the LNG to the heat exchanger.

18. The apparatus according to claim 17, further comprising:
a heater to heat a heat transfer medium having been subjected to heat exchange with the air for combustion while passing through the heat exchanger.

19. The apparatus according to claim 17, further comprising:
an LNG vaporizer to regasify the LNG stored in the LNG cargo tank wherein the air for combustion supplied to the gas turbine is cooled by the cold source generated upon regasification of the LNG in the LNG vaporizer.

20. The apparatus according to claim 17 wherein the heat transfer medium circuit includes a transfer pump and an adjusting valve to adjust an amount of heat transfer medium transferred by the transfer pump.
